(19) United States
(12) Patent Application Publication
(10) Pub. No.: US 2024/0391540 A1
(43) Pub. Date: Nov. 28, 2024

(54) SYSTEM FOR HARVESTING ENERGY OF MOBILITY VEHICLE

(71) Applicants: Hyundai Motor Company, Seoul (KR); Kia Corporation, Seoul (KR)

(72) Inventors: Hong Heui Lee, Suwon (KR); Dong Eun Cha, Hwaseong (KR); Jin Young Yoon, Gimpo (KR)

(21) Appl. No.: 18/383,779

(22) Filed: Oct. 25, 2023

(30) Foreign Application Priority Data
May 24, 2023 (KR) 10-2023-0067074

(51) Int. Cl. B62D 35/00; B62D 37/02

(52) U.S. Cl. CPC B62D 35/007; B62D 37/02

(57) ABSTRACT

A system for harvesting energy of a mobility vehicle includes a spoiler provided on the mobility vehicle in which an angle of the spoiler is varied so as to adjust an air flow, a driver installed on the mobility vehicle to generate a driving force such that the spoiler is tilted in at least one direction to change the angle of the spoiler, a solar cell module installed on the spoiler so as to convert light energy into electric energy, and a controller configured to control the driver according to a traveling speed of the mobility vehicle or according to whether light energy is input, thereby determining the angle of the spoiler. By adjusting the tilting angle of the spoiler, it is possible to improve aerodynamic performance and efficiency of electric energy generation through the solar cell module.

### CROSS-REFERENCE TO RELATED APPLICATION(S)

This application claims under 35 U.S.C. 119 the benefit of Korean Patent Application No. 10-2023-0067074, filed on May 24, 2023 in the Korean Intellectual Property Office, the entire contents of which are incorporated by reference herein.

### BACKGROUND

### 1. Technical Field

The present disclosure relates to a system for harvesting energy of a mobility vehicle, more particularly, to the system in which a tilting angle of a spoiler is adjusted according to a traveling state of the mobility vehicle, in order generate electric energy through a solar cell module provided on the spoiler and improve aerodynamic performance.

### 2. Description of the Related Art

Mobility devices or mobility vehicles such as bicycles and kickboards are typically used both as exercise equipment for daily sports and recreation, and also for short-distance transportation in urban areas. A mobility vehicle may include, for example, an electric kickboard, a delivery robot car, an electric bicycle, an electric wagon, an electric stroller, and other mobility devices/vehicles.

When a mobility vehicle travels at a high speed or pivots, the grip of rear-wheel tires weakens, thereby posing a problem in that the traveling speed cannot be increased easily, and traveling stability deteriorates.

Accordingly, devices for improving aerodynamics have been applied, such as air spoilers and air skirts.

An air spoiler is installed on the back of a mobility vehicle so as to change the flow air that passes through the mobility vehicle such that the air stream around the air spoiler generates a downward pressure on the mobility vehicle, thereby improving the grip of the rear-wheel tires.

An air skirt is intended to solve the problem of degraded traveling stability occurring when an increased amount of air flows in under the front bumper and thus lifts the mobility vehicle, thereby weakening the grip of tires. The air skirt is therefore installed on the lower end of the front bumper so as to decrease the amount of air flowing in under the front bumper such that the drag and lift are reduced, thereby improving the grip of tires.

However, conventional devices for controlling the air flow are always drawn out or are controlled according to the traveling speed, but do not apply no other additional functions.

The above descriptions regarding background technologies have been made only to help understanding of the background of the present disclosure, and are not to be deemed by those skilled in the art to correspond to already-known prior arts.

### SUMMARY

The present disclosure provides a system for harvesting energy and improving aerodynamics, in which a tilting angle of a spoiler is adjusted according to a traveling state of a mobility vehicle, in order to improve aerodynamic performance, and electric energy is generated through a solar cell module provided on the spoiler.

In accordance with an aspect of the present disclosure, a system, e.g., for harvesting energy of a mobility vehicle includes: a spoiler provided on an outer surface of the mobility vehicle and formed to have a predetermined area such that an air flow is adjusted according to an angle; a driver installed on the mobility vehicle such that the spoiler is mounted thereon, and configured to generate a driving force when operating such that the spoiler is tilted in at least one direction, thereby changing the angle; a solar cell module installed on the spoiler so as to convert light energy into electric energy; and a controller configured to control the driver according to a traveling speed of the mobility vehicle or according to whether light energy is input, thereby determining the angle of the spoiler.

The spoiler is configured to be tilted in the at least one direction being forwards, backwards, leftwards, or rightwards.

Multiple spoilers may be configured on the outer surface of the mobility vehicle, each spoiler may be equipped with a driver, and respective drivers may operate simultaneously or individually under the control of the controller to allow angles of respective spoilers to be differently adjusted.

The driver may include a housing, a first driving portion, and a second driving portion, the first driving portion may be configured such that the spoiler is tilted forwards/backwards, and the second driving portion may be configured such that the spoiler is tilted leftwards/rightwards.

The housing may include a lower cover and an upper cover, the lower cover may be fixedly installed on the mobility vehicle, the upper cover may be provided above the lower cover such that the angle thereof is changed, the spoiler may be coupled to the upper cover, and the first driving portion and the second driving portion may be mounted on the lower cover and connected to the upper cover such that, when operating, the position of the upper cover is adjusted.

The first driving portion may include a first actuator and a first link, the first actuator may be installed on the lower cover so as to generate a driving force, the first link may be connected to the upper cover so as to receive the driving force from the first actuator and to move accordingly, the second driving portion may include a second actuator and a second link, the second actuator may be installed on the lower cover so as to generate a driving force, and the second link may be connected to the upper cover so as to receive the driving force from the second actuator and to move in a different direction from the first link.

The first actuator may include a first motor portion and a first gear portion configured to receive power from the first motor portion and to rotate accordingly, the first gear portion may be configured to mesh with an outer or inner peripheral surface of the first link, the second actuator may include a second motor portion and a second gear portion configured to receive power from the second motor portion and to rotate accordingly, and the second gear portion may be configured to mesh with an outer or inner peripheral surface of the second link.

The first link and the second link may be formed so as to bend such that, when respective actuators operate, the first link and the second link rotate in bending directions.

The first link may be disposed to rotate forwards/backwards, and the second link is disposed to rotate leftwards/rightwards.

The controller may control the driver, if the mobility vehicle travels at a preset speed or higher, such that the spoiler is tilted so as to slope downwards while facing forwards.

The controller may control the driver such that the tilting angle of the spoiler, which slopes downwards while facing forwards, increases according to the traveling velocity of the mobility vehicle, which increases beyond the preset speed.

The controller may control the driver such that the spoiler is tilted so as to slope downwards while facing backwards if the mobility vehicle is decelerated below a braking sensing speed within a preset time.

The system for harvesting energy and improving aerodynamics may further include a sunlight sensing portion configured to identify the sun's position information, and the controller may control the driver such that the solar cell module follows the sun's position according to the sun's position identified through the sunlight sensing portion, thereby adjusting the position of the spoiler.

The controller may adjust the position of the spoiler according to the sun's position input through the sunlight sensing portion when the mobility vehicle is traveling at a low speed or is stationary.

The sunlight sensing portion may identify the sun's position in current position of the mobility vehicle by aggregating the current position of the mobility vehicle, time, and weather information.

The sunlight sensing portion may include photosensor modules configured to sense the amount of solar radiation such that the sun's position is identified according to the intensity of solar radiation input to respective photosensor modules.

Multiple controllers may be configured, respective spoilers may be provided with solar cell modules, and the controller individually may control respective spoiler positions such that respective solar cell modules follow the sun's position identified through the sunlight sensing portion.

The controller may receive an additional input regarding whether obstacles, including buildings, exist around the mobility vehicle, and may adjust the spoiler to the initial position when the sun's position identified through the sunlight sensing portion matches with an obstacle.

The sunlight sensing portion may identify the sun's position over time, and the controller adjusts the position of the spoiler such that the solar cell module follows the sun's position if it is confirmed that light is be incident onto the mobility vehicle as a result of a change in the sun's position over time.

The solar cell module may be detachably installed on the spoiler.

A mobility vehicle may incorporate the above-described system.

A system, e.g., for harvesting energy and improving aerodynamics, which has the above-mentioned structure, is advantageous in that the tilting angle of a spoiler is adjusted according to the traveling state of a mobility vehicle, thereby improving aerodynamic performance.

In addition, electric energy is generated from light energy through a solar cell module provided on the spoiler, and the angle of the spoiler is adjusted according to the position of the sun such that the solar cell module follows the position of the sun, thereby improving the efficiency of electric energy generation through the solar cell module.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates a spoiler of a system for harvesting energy and improving aerodynamics according to the present disclosure;

FIG. 2 is an assembled view of a spoiler and a solar cell module of a system for harvesting energy and improving aerodynamics according to an embodiment of the present disclosure;

FIG. 3 illustrates a spoiler of a system for harvesting energy and improving aerodynamics according to another embodiment of the present disclosure;

FIG. 4 is an assembled view of a spoiler and a solar cell module of a system for harvesting energy and improving aerodynamics according to another embodiment of the present disclosure;

FIG. 5 illustrates a spoiler and a driver according to the present disclosure;

FIG. 6 illustrates operations of the spoiler and the driver illustrated in FIG. 5;

FIG. 7 illustrates a driver according to the present disclosure;

FIG. 8 illustrates an upper cover of a driver according to the present disclosure;

FIG. 9 illustrates a lower cover of a driver according to the present disclosure;

FIG. 10 is a flowchart wherein a spoiler of a system for harvesting energy and improving aerodynamics according to the present disclosure is controlled according to the traveling speed; and

FIG. 11 is a flowchart wherein a spoiler of a system for harvesting energy and improving aerodynamics according to the present disclosure is controlled according to the position of the sun.

### DETAILED DESCRIPTION OF THE EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, embodiments disclosed in the present specification will be described in detail with reference to the accompanying drawings, and the same or similar elements are given the same and similar reference numerals, so duplicate descriptions thereof will be omitted.

In describing the embodiments disclosed in the present specification, when the detailed description of the relevant known technology is determined to unnecessarily obscure the gist of the present disclosure, the detailed description may be omitted. Furthermore, the accompanying drawings are provided only for easy understanding of the embodiments disclosed in the present specification, and the technical spirit disclosed herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for the purpose of distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

A controller may include a communication device configured to communicate with a sensor or another control unit, a memory configured to store an operation system, a logic command, or input/output information, and at least one processor configured to perform determination, calculation, decision or the like which are required for responsible function controlling.

Hereinafter, a system for harvesting energy and improving aerodynamics according to an exemplary embodiment of the present disclosure will be described with reference to the accompanying drawings.

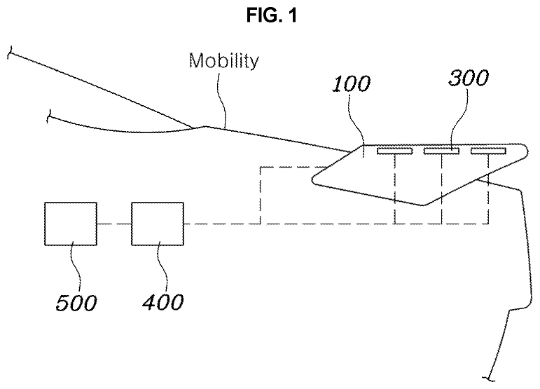

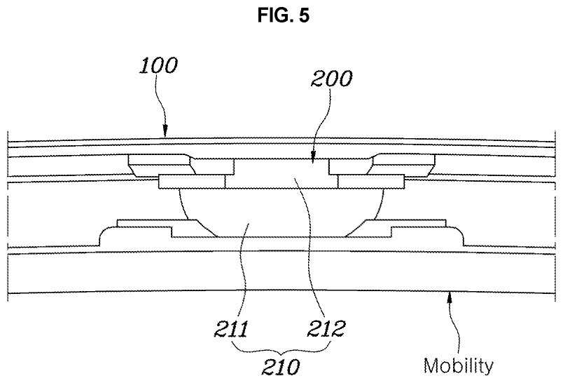

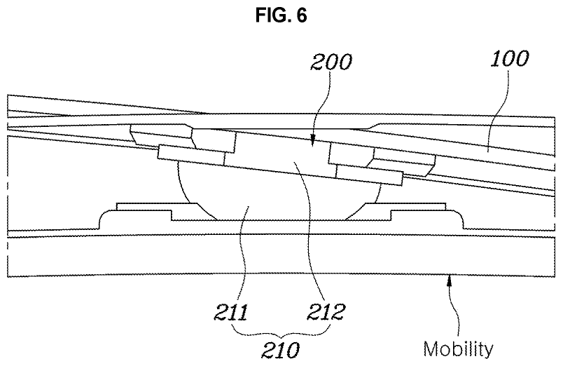

A system for harvesting energy and improving aerodynamics according to an embodiment of the present disclosure includes, as illustrated in FIGS. 1 to 6, a spoiler 100 provided on the outer surface of a mobility vehicle and formed to have a predetermined area such that the air flow is adjusted according to the angle; a driver 200 installed on the mobility vehicle, the spoiler 100 being mounted thereon, and configured to generate a driving force when operating, thereby tilting the spoiler 100 in at least one direction (e.g., forwards/backwards/leftwards/rightwards) such that the angle thereof is changed; a solar cell module 300 installed on the spoiler 100 so as to convert light energy into electric energy; and a controller 400 configured to control the driver 200 according to the traveling speed of the mobility vehicle or according to whether light energy is input, thereby determining the angle of the spoiler 100.

According to the present disclosure, the tilting angle of the spoiler 100 is adjusted to improve aerodynamic performance, and electric energy is accumulated through the solar cell module 300 provided on the spoiler 100. Particularly, the spoiler 100 follows the direction in which light energy is input, thereby adjusting the position of the spoiler 100, such that the solar cell module 300 receives light energy to the maximum extent, thereby improving the efficiency of electric energy generated from light energy.

The spoiler 100 according to the present disclosure may be provided on the outer surface of the mobility vehicle.

The outer surface of the mobility vehicle, as used herein, may include the upper surface of the mobility vehicle, a side surface thereof, and any range in which sunlight can be incident, and in which a solar cell module can be attached. The spoiler 100 according to the present disclosure may be installed on the rear upper surface of the mobility vehicle or on the roof thereof in order to improve aerodynamic performance and to increase the efficiency of energy generation through the solar cell module.

The spoiler 100 may have a wing shape to influence the air flow, and may have a predetermined area such that the air flow is adjusted, and such that the solar cell module 300 can be installed on the upper surface.

The driver 200 is installed on the mobility vehicle so as to generate a driving force such that the spoiler 100 is tilted forwards/backwards/leftwards/rightwards such that the angle thereof is changed. The driver 200 allows the position of the spoiler 100 to be adjusted in the forward/backward direction and in the leftward/rightward direction such that the tilting angle of the spoiler 100 can be changed by 360°.

The solar cell module 300 is a device for converting light energy into electric energy, and is installed on the outer surface of the spoiler 100 to be exposed to the outside. Accordingly, the position of the solar cell module 300 is changed when the spoiler 100 is tilted and has a changed angle, thereby switching the direction in which light energy is received according to the position of the spoiler 100.

As a result, the controller 400 according to the present disclosure controls the driver 200 according to the traveling speed of the mobility vehicle or according to the direction in which light energy is incident such that the tilting angle of the spoiler 100 is adjusted, thereby improving the air flow and increasing the efficiency of conversion from light energy to electric energy through the solar cell module 300.

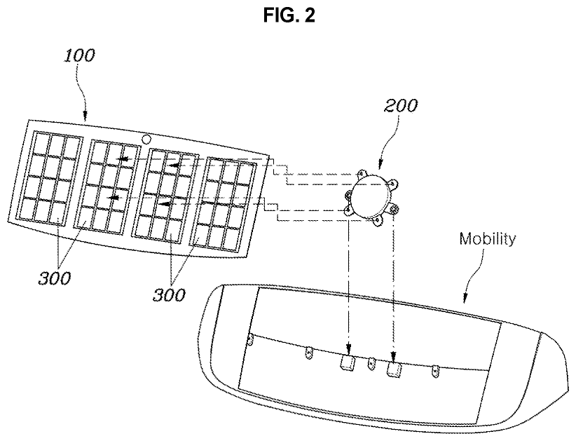

The above-described present disclosure will now be described in detail. As illustrated in FIG. 1 and FIG. 2, the spoiler 100 according to an embodiment may be configured as a single entity.

The spoiler 100 may be installed on the rear side of the mobility vehicle as a rear spoiler 100, and the tilting angle thereof may be adjusted in the forward/backward or leftward/rightward direction under the control of the driver 200. The spoiler 100 may be provided with multiple solar cell modules 300.

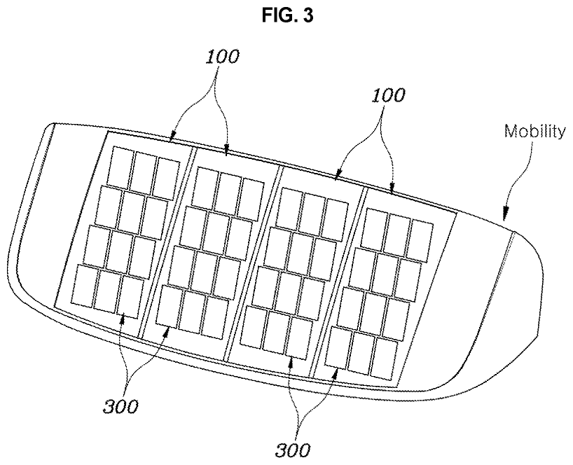

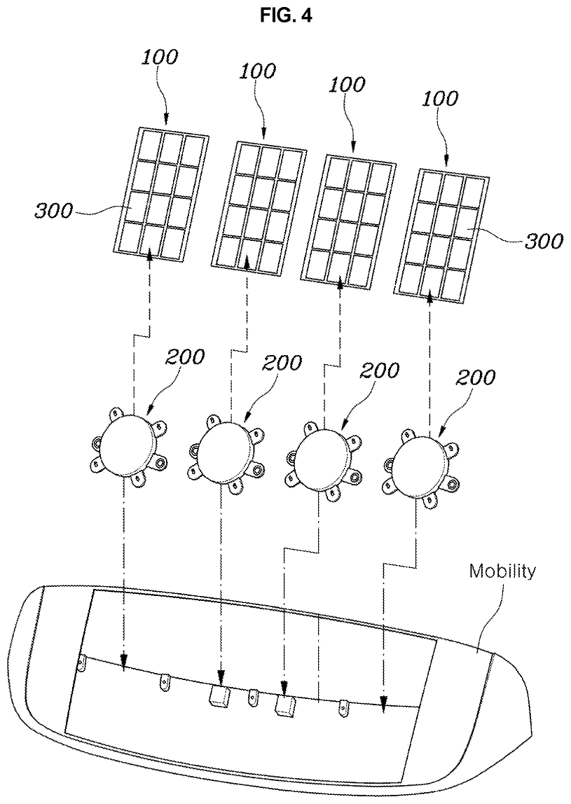

In another embodiment, as illustrated in FIG. 3 and FIG. 4, multiple spoilers 100 may be provided on the outer surface of the mobility vehicle, and drivers 200 may be mounted on respective spoilers 100. Respective drivers 200 may operate simultaneously or individually under the control of the controller 400 such that the angle of respective spoilers 100 can be adjusted differently.

That is, multiple spoilers 100 may be provided on the mobility vehicle, and respective spoilers 100 may be equipped with drivers 200 so as to operate individually. Accordingly, the controller 400 may control respective drivers 200 simultaneously or individually, and the tilting angle of respective spoilers 100 may be adjusted simultaneously or individually such that they can be implemented in various types optimized for the traveling speed of the mobility vehicle, the direction of traveling, or external design elements.

Meanwhile, solar cell modules 300 may be detachably installed on respective spoilers 100 such that even if some of the multiple solar cell modules 300 malfunction, the malfunctioning solar cell modules 300 can be selectively replaced, thereby facilitating quality management. In addition, solar cell modules 300 may be selectively mounted on spoilers 100 according to the spoiler design or according to whether electric energy is generated through the solar cell modules 300, thereby guaranteeing user satisfaction.

Meanwhile, each driver 200 according to the present disclosure may include a housing 210, a first driving portion 220, and a second driving portion 230.

The housing 210 may be installed on the mobility vehicle. The first driving portion 220 and the second driving portion 230 provided in the housing 210 may be connected to a spoiler 100 such that the tilting angle of the spoiler 100 is adjusted according to whether first driving portion 220 and the second driving portion 230 operate.

The first driving portion 220 may be configured such that the spoiler 100 is tilted in the forward/backward direction, and the second driving portion 230 may be configured such that the spoiler 100 is tilted in the leftward/rightward direction. Accordingly, the driver 200 may adjust the tilting angle of the spoiler 100 in the forward/backward direction when the first driving portion 220 is driven, and may adjust the tilting angle of the spoiler 100 in the leftward/rightward direction as well when the second driving portion 230 is driven together, thereby adjusting the position of the spoiler 100 by 360°.

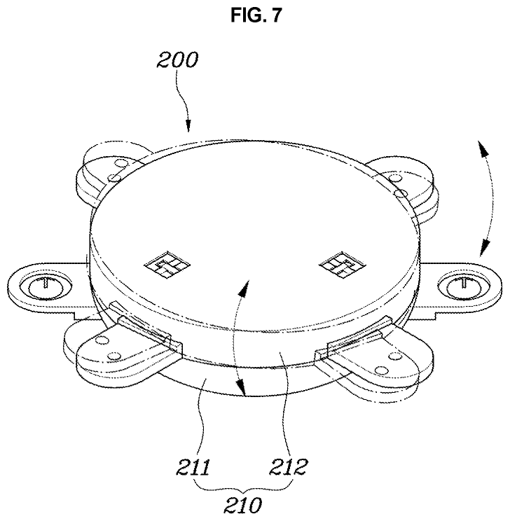

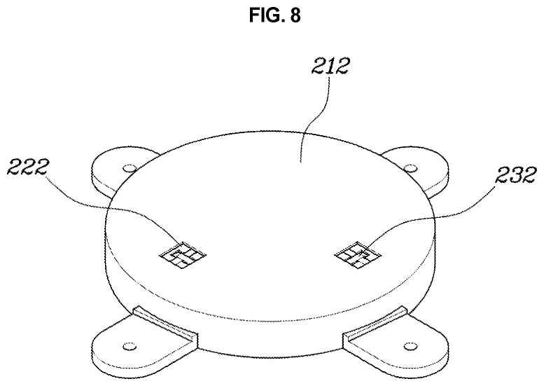

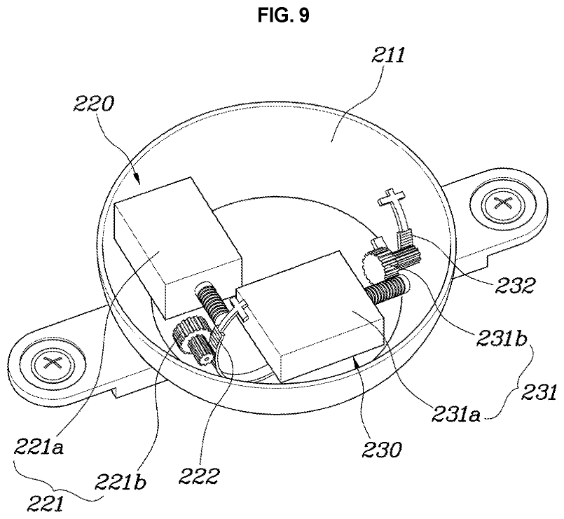

Specifically, as illustrated in FIGS. 7 to 9, the housing 210 includes a lower cover 211 and an upper cover 212. The lower cover 211 is fixedly installed on the mobility vehicle, and the upper cover 212 is provided above the lower cover 211 such that the angle thereof can be changed, and a spoiler 100 may be coupled to the upper cover 212.

The lower cover 211 may have an open upper surface. A first driving portion 220 and a second driving portion 230 are provided in the lower cover 211, and the lower surface of the lower cover 211 is fixed to the mobility vehicle.

The upper cover 212 is positioned above the lower cover 211. The lower surface of the upper cover 212 is open, and a spoiler 100 is coupled to the upper surface thereof. The inner diameter of the upper cover 212 may be larger than that of the lower cover 211 such that, even if the tilting angle is changed above the lower cover 211, interference with the lower cover 211 can be avoided.

The first driving portion 220 and the second driving portion 230 are provided inside the lower cover 211 and connected to the upper cover 212 as described above such that, when the first driving portion 220 and the second driving portion 230 operate, the position of the spoiler 100 can be adjusted while being interlocked with forward/backward/leftward/rightward adjustment of the position of the upper cover 212.

In an embodiment of the first driving portion 220 and the second driving portion 230, the first driving portion 220 may include a first actuator 221 and a first link 222. The first actuator 221 may be installed on the lower cover 211 so as to generate a driving force. The first link 222 may be connected to the upper cover 212 and configured to receive the driving force from the first actuator 221 and to move accordingly. The second driving portion 230 may include a second actuator 231 and a second link 232. The second actuator 231 may be installed on the lower cover 211 so as to generate a driving force. The second link 232 may be connected to the upper cover 212 and configured to receive the driving force from the second actuator 231 and to move in a different direction from the first link 222.

As such, the first driving portion 220 includes a first actuator 221 and a fist link 222, the second driving portion 230 includes a second actuator 231 and a second link 232, and respective links thus move when respective actuators operate, thereby moving the upper cover 212 in the upward/downward direction. The first link 222 and the second link 232 are configured to move in different directions when respective actuators operate.

That is, the first link 222 and the second link 232 may be bent so as to make rotate in bending directions when respective actuators operate. The first link 222 and the second link 232 may be bent toward the inside of the housing 210 such that the tilting angle of the spoiler 100 is determined by movements of respective links caused by operations of the first driving portion 220 and the second operating portion 230 along the bent shape of the first link 222 and the second link 232. For example, when the first link 222 is rotated in the forward/backward direction by the operation of the first actuator 221, the tilting angle of the upper cover 212 may be adjusted in the forward/backward direction, and when the second link 232 is rotated in the leftward/rightward direction by the operation of the second actuator 231, the tilting angle of the upper cover 212 may be adjusted in the leftward/rightward direction. As a result, the spoiler 100 coupled to the upper cover 212 may interwork with rotations of the first link 222 and the second link 232 such that the tilting angle thereof is adjusted by 360° forwards/backwards/leftwards/rightwards.

Accordingly, the first driving portion 220 and the second driving portion 230 may be disposed inside the lower cover 211 perpendicularly to each other while being spaced apart from each other.

Meanwhile, the first driving portion 220 and the second driving portion 230 will now be described in detail. The first actuator 221 may include a first motor portion 221a and a first gear portion 221b configured to receive power from the first motor portion 221a and to rotate accordingly. The first gear portion 221b may mesh with the outer or inner peripheral surface of the first link 222. The second actuator 231 may include a second motor portion 231a and a second gear portion 231b configured to receive power from the second motor portion 231a and to rotate accordingly. The second gear portion 231b may mesh with the outer or inner peripheral surface of the second link 232.

As such, the first actuator 221 includes a first motor portion 221a and a first gear portion 221b, and the second actuator 231 includes a second motor portion 231a and a second gear portion 231b.

The first motor portion 221a and the second motor portion 231a are configured to generate a rotating force, and the first gear portion 221b and the second gear portion 231b receive rotating power through respective motor portions and thus rotate. Particularly, the outer or inner peripheral surface of the first link 222 may mesh with the first gear portion 221b, and the outer or inner peripheral surface of the second link 232 may mesh with the second gear portion 231b such that respective links rotate in proportion to the amount of rotation of respective gear portions.

In addition, in the case of the first motor portion 221a, the first gear portion 221b, and the first link 222, which constitute the first driving portion 220, and the second motor portion 231a, the second gear portion 231b, and the second link 232, which constitute the second driving portion 230, respective components may be disposed perpendicularly such that the first link 222 and the second link 232 rotate in different directions.

That is, the first link 222 is disposed to rotate in the forward/backward direction, and the second link 232 is disposed to rotate in the leftward/rightward direction such that the tilting angle of the upper cover 212, to which the first link 222 and the second link 232 are connected, and that of the spoiler 100 can be freely changed forwards/backwards/leftwards/rightwards.

In addition, multiple first driving portion 220 and multiple second driving portion 230 may be configured with identical specifications, respectively, such that an increased number of first links 222 and second links 232 are connected to the upper cover 212, thereby securing the rigidity of coupling to the upper cover 212.

The spoiler 100 according to the present disclosure described above has a tilting angle determined under the control of the controller 400.

Specifically, the controller 400 may control the driver 200 if the traveling speed of the mobility vehicle is a preset speed or higher such that the spoiler 100 is tilted so as to slope downwards while facing forwards.

The preset speed may refer to a high speed at which the mobility vehicle travels, and at which the mobility vehicle is influenced by air.

If the traveling speed of the mobility vehicle is confirmed to be the preset speed or higher, the controller 400 controls the driver 200 such that the spoiler 100 is tilted so as to slope downwards while facing forwards. As a result, the mobility vehicle has an increased downforce by the spoiler 100, thereby improving high-speed stability.

In addition, the controller 400 may control the driver 200 such that the tilting angle of the spoiler 100, which slopes downwards, increases according to the traveling speed of the mobility vehicles, which increases beyond a preset speed.

That is, the controller 400 increases the tilting angle of the spoiler 100, which slopes downwards, if the traveling speed of the mobility vehicle continuously accelerates, while the spoiler 100 slope downwards while facing forwards, because the traveling speed of the mobility vehicle corresponds to a preset speed or higher, thereby increasing the downforce generated by the spoiler 100.

For example, if the traveling speed of the mobility vehicle is 80 km/h (preset speed), the angle of the spoiler 100 may be titled only by 30%, if the traveling speed reaches 120 km/h, the angle of the spoiler 100 may be titled by 60%, and if the traveling speed reaches 180 km/h, the angle of the spoiler 100 may be titled by 100% (maximum angle).

Accordingly, the tilting angle of the spoiler 100 is adjusted according to the traveling speed of the mobility vehicle during acceleration such that a downforce appropriate for the current traveling speed is generated, thereby securing high-speed traveling stability.

Meanwhile, if the traveling speed of the mobility vehicle decelerates below a braking sensing speed withing a preset time, the controller 400 may control the driver 200 such that the spoiler 100 is tilted so as to slope downwards while facing backwards.

That is, if the mobility vehicle is rapidly decelerated, the controller 400 may tilt the spoiler 100 so as to slope downwards while facing backwards, thereby generating an air braking effect.

The braking sensing speed may be set according to the deceleration of the mobility vehicle. Accordingly, if the mobility vehicle is rapidly decelerated to reach the braking sensing speed within a preset time, the controller 400 may tilt the spoiler 100 so as to slope downwards while facing backwards such that, by generating a resistance to the air flow, braking is performed by the air resistance.

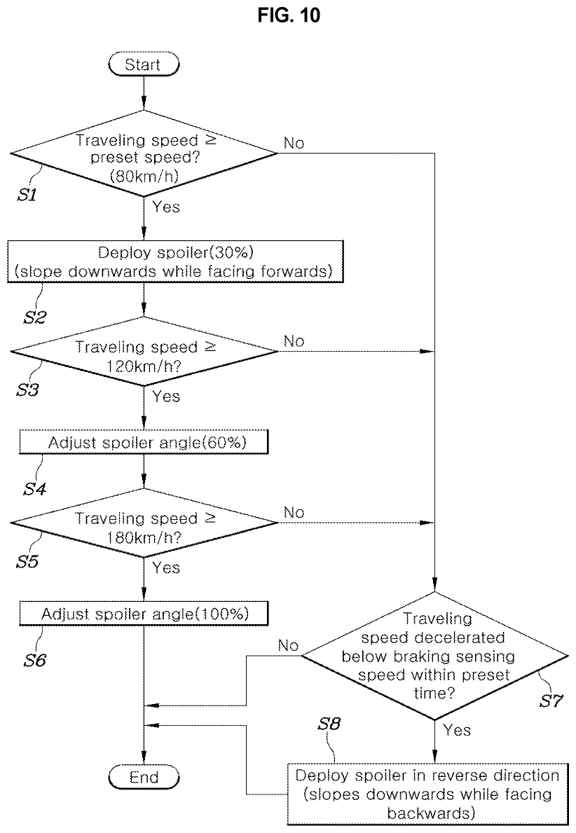

The above-described control of the spoiler according to the traveling speed of the mobility vehicle may be performed according to S1-S8 in the flowchart of FIG. 10.

Meanwhile, in order to improve the efficiency of conversion from light energy to electric energy, the position of the spoiler 100 is adjusted, according to the present disclosure, such that the solar cell module 300 provided on the spoiler 100 follows the position of the sun.

Therefore, the present disclosure further includes a sunlight sensing portion 500 configured to identify the sun's position information.

Accordingly, the controller 400 may control the driver 200 according to the sun's position identified by the sunlight sensing portion 500 so as to adjust the position of the spoiler 100 such that the solar cell module 300 follows the sun's position.

That is, if the sunlight sensing portion 500 identifies the sun's position, the controller 400 adjusts the position of the spoiler 100 such that the solar cell module 300 faces the sun according to the sun's position input through the sunlight sensing portion 500. As a result, the solar cell module 300 can follow the sun's position and thus receive light energy to the maximum extent, thereby increasing the amount of electric energy generated from light energy.

In an embodiment of the sunlight sensing portion 500, the sunlight sensing portion 500 may identify the sun's position in the current position of the mobility vehicle by aggregating the mobility vehicle's current position, time, and weather information.

That is, the sunlight sensing portion 500 may aggregate the sun's position information according to the mobility vehicle's current position and time through the GPS and external communication, thereby identifying the sun's position with reference the current mobility vehicle's position. Furthermore, the sun's position may be identified on the basis of sunrise and sunset information by aggregating weather information.

In another embodiment of the sunlight sensing portion 500, the sunlight sensing portion 500 may include photosensor modules configured to sense the amount of solar radiation such that the sun's position can be identified according to the intensity of solar radiation input to each photosensor module.

That is, the sunlight sensing portion 500 may include four photosensor modules disposed in the eastward, westward, southward, and northward direction, respectively. Accordingly, the amount of solar radiation input to respective photosensor modules may be checked according to the sun's position with reference to the current mobility vehicle's position, and it may be recognized that the sun is positioned in a direction with a high strength of solar radiation.

The sunlight sensing portion 500 may be implemented in various embodiments such that the sun's position is identified through the sunlight sensing portion 500, and the controller 400 may control the driver 200 such that the solar cell module 300 provided on the spoiler 100 follows the sun's position according to the sun's position with reference to the current mobility vehicle's position.

When the mobility vehicle is traveling at a low speed or is stationary, the controller 400 adjusts the position of the spoiler 100 according to the sun's position input through the sunlight sensing portion 500.

That is, when the spoiler 100 is manipulated such that the solar cell module 300 follows the sun's position, an air resistance may be generated through the spoiler 100, thereby degrading the traveling performance. Therefore, if degradation of the traveling performance by the spoiler 100 is avoided because the mobility vehicle is traveling at a low speed or is stationary, the controller 400 adjusts the position to the spoiler 100 to the sun's position input through the sunlight sensing portion 500.

Preferably, the position of the spoiler 100 is adjusted so as to secure aerodynamic performance when the mobility vehicle is traveling, and electric energy may be generated through the solar cell module 300 when the mobility vehicle is stationary.

Meanwhile, multiple spoilers 100 may be provided, each spoiler 100 may be provided with a solar cell module 300, and the controller 400 may individually control the position of respective spoilers 100 such that respective solar cell modules 300 follow the sun's position identified through the sunlight sensing portion 500.

The mobility vehicle may include multiple spoilers 100, and drivers 200 may be mounted on respective spoilers 100 so as to operate individually. Accordingly, the controller 400 may control respective drivers 200 simultaneously or individually, and the tilting angle of respective spoilers 100 may be adjusted simultaneously or individually.

Particularly, each spoiler 100 has a solar cell module 300, and multiple spoilers 100 are disposed to be spaced apart from the mobility vehicle. Therefore, when respective solar cell modules 300 follow the sun's position, respective spoilers 100 need to be positioned differently.

Therefore, the controller 400 may individually control respective spoilers 100 such that respective solar cell modules 300 receive energy to the maximum extent according to the sun's position identified through the sunlight sensing portion 500. As a result, respective solar cell modules 300 provided on respective spoilers 100 may follow the sun, thereby securing the maximum amount of electric energy generation.

Meanwhile, the controller 400 may receive an additional input regarding whether obstacles, including buildings, exist around the mobility vehicle. If the sun's position identified through the sunlight sensing portion 500 matches with an obstacle, the controller 400 may adjust the spoiler 100 to the initial position.

The controller 400 may identify buildings currently positioned around the mobility vehicle on the basis of map data. Particularly, if the sun's position identified through the sunlight sensing portion 500 matches with a nearby building, and it is thus confirmed that the mobility vehicle in the current position will be shaded, the controller 400 adjusts the spoiler 100 to the initial position because the efficiency of electric energy generation through the solar cell module 300 will be degraded. The initial position of the spoiler 100 may be the position of the undeployed spoiler 100 or the previous position of the spoiler 100.

Thereafter, the sunlight sensing portion 500 may identify the sun's position over time. If light is incident onto the mobility vehicle after the sun's position is changed over time, the controller 400 may adjust the position of the spoiler 100 such that the solar cell module 300 follows the sun, thereby generating electric energy through the solar cell module 300. As a result, even when the mobility vehicle is parked, electric energy may be selectively generated through the solar cell module 300 according to the sun's position over time, thereby improving the efficiency of electric energy generation.

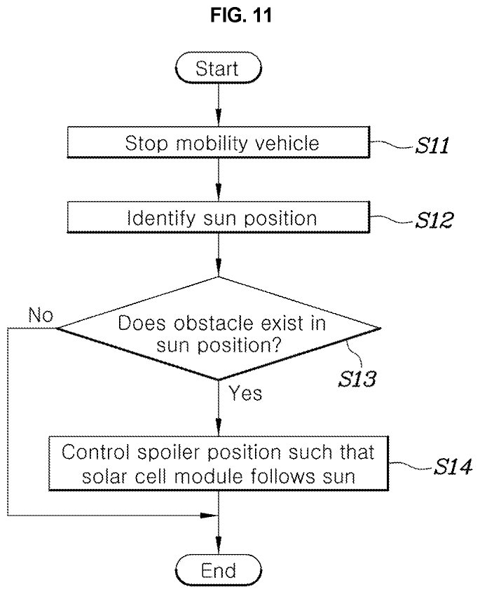

Such control of the spoiler according to the sun's position may be performed through S11-S14 in the flowchart of FIG. 11.

The system for harvesting energy and improving aerodynamics, which has the above-described structure, adjusts the tilting angle of the spoiler 100 according to the traveling state of the mobility vehicle, thereby improving aerodynamic performance.

In addition, electric energy is generated from light energy through the solar cell module 300 provided on the spoiler 100, and the angle of the spoiler 100 is adjusted according to the sun's position such that the solar cell module 300 follows the sun's position, thereby improving the efficiency of electric energy generation through the solar cell module 300.

Although the present disclosure has been described and illustrated in conjunction with particular embodiments thereof, it will be apparent to those skilled in the art that various improvements and modifications may be made to the present disclosure without departing from the technical idea of the present disclosure defined by the appended claims.

What is claimed is:

1. A system for harvesting energy of a mobility vehicle, the system comprising:
a spoiler provided on an outer surface of the mobility vehicle, wherein an angle of the spoiler is adjusted so as to adjust an air flow;
a driver installed on the mobility vehicle for mounting the spoiler, the driver configured to generate a driving force when operating such that the spoiler is tilted in at least one direction, thereby changing the angle of the spoiler;
a solar cell module installed on the spoiler so as to convert light energy into electric energy; and
a controller configured to control the driver according to a traveling speed of the mobility vehicle or according to whether light energy is input, thereby determining the angle of the spoiler.

2. The system of claim 1, wherein the spoiler is configured to be tilted in the at least one direction being forwards, backwards, leftwards, or rightwards.

3. The system of claim 1, wherein multiple spoilers are configured on the outer surface of the mobility vehicle, each of the multiple spoilers being equipped with a respective driver, and the respective drivers configured to operate simultaneously or individually under the control of the controller to allow angles of the respective spoilers to be differently adjusted.

4. The system of claim 1, wherein the driver comprises a housing, a first driving portion, and a second driving portion, the first driving portion is configured such that the spoiler is tilted forwards/backwards, and the second driving portion is configured such that the spoiler is tilted leftwards/rightwards.

5. The system of claim 4, wherein the housing comprises a lower cover and an upper cover, the lower cover is fixedly installed on the mobility vehicle, the upper cover is provided above the lower cover such that the angle thereof is changed, the spoiler is coupled to the upper cover, and the first driving portion and the second driving portion are mounted on the lower cover and connected to the upper cover such that, when operating, the position of the upper cover is adjusted.

6. The system of claim 5, wherein the first driving portion comprises a first actuator and a first link, the first actuator is installed on the lower cover so as to generate a driving force, the first link is connected to the upper cover so as to receive the driving force from the first actuator and to move accordingly, the second driving portion comprises a second actuator and a second link, the second actuator is installed on the lower cover so as to generate a driving force, and the second link is connected to the upper cover so as to receive the driving force from the second actuator and to move in a different direction from the first link.

7. The system of claim 6, wherein the first actuator comprises a first motor portion and a first gear portion configured to receive power from the first motor portion and to rotate accordingly, the first gear portion is configured to mesh with an outer or inner peripheral surface of the first link, the second actuator comprises a second motor portion and a second gear portion configured to receive power from the second motor portion and to rotate accordingly, and the second gear portion is configured to mesh with an outer or inner peripheral surface of the second link, or the first link and the second link are formed so as to bend such that, when respective actuators operate, the first link and the second link rotate in bending directions.

8. The system of claim 6, wherein the first link is disposed to rotate forwards/backwards, and the second link is disposed to rotate leftwards/rightwards.

9. The system of claim 1, wherein the controller controls the driver, if the mobility vehicle travels at a preset speed or higher, such that the spoiler is tilted so as to slope downwards while facing forwards.

10. The system of claim 9, wherein the controller controls the driver such that the tilting angle of the spoiler, which slopes downwards while facing forwards, increases according to the traveling velocity of the mobility vehicle, which increases beyond the preset speed.

11. The system of claim 1, wherein the controller controls the driver such that the spoiler is tilted so as to slope downwards while facing backwards if the mobility vehicle is decelerated below a braking sensing speed within a preset time.

12. The system of claim 1, further comprising a sunlight sensing portion configured to identify the sun's position information, wherein the controller controls the driver such that the solar cell module follows the sun's position according to the sun's position identified through the sunlight sensing portion, thereby adjusting the position of the spoiler.

13. The system of claim 12, wherein the controller adjusts the position of the spoiler according to the sun's position input through the sunlight sensing portion when the mobility vehicle is traveling at a low speed or is stationary.

14. The system of claim 12, wherein the sunlight sensing portion identifies the sun's position in current position of the mobility vehicle by aggregating the current position of the mobility vehicle, time, and weather information.

15. The system of claim 12, wherein the sunlight sensing portion comprises photosensor modules configured to sense the amount of solar radiation such that the sun's position is identified according to the intensity of solar radiation input to respective photosensor modules.

16. The system of claim 12, wherein multiple controllers are configured, respective spoilers are provided with solar cell modules, and the controller individually controls respective spoiler positions such that respective solar cell modules follow the sun's position identified through the sunlight sensing portion.

17. The system of claim 12, wherein the controller receives an additional input regarding whether obstacles, including buildings, exist around the mobility vehicle, and adjusts the spoiler to the initial position when the sun's position identified through the sunlight sensing portion matches with an obstacle.

18. The system of claim 17, wherein the sunlight sensing portion identifies the sun's position over time, and the controller adjusts the position of the spoiler such that the solar cell module follows the sun's position if it is confirmed that light is incident onto the mobility vehicle as a result of a change in the sun's position over time.

19. The system of claim 1, wherein the solar cell module is detachably installed on the spoiler.

20. A mobility vehicle comprising the system of claim 1.
